(19) United States
(12) Patent Application Publication
(10) Pub. No.: US 2026/0303643 A1
(43) Pub. Date: Oct. 1, 2026

(54) THREAT DETECTION AND INDICATORS OF COMPROMISE DETECTION IN AUTONOMOUS PENTESTING

(71) Applicant: Horizon 3 AI, Inc., Dover, DE (US)

(72) Inventors: Naveen Naga Sunkavally, Cary, NC (US); Snehal Antani, San Francisco, CA (US); Anthony Pillitiere, Wesley Chapel, FL (US); Travis Fahlgren, Carthage, NC (US)

(21) Appl. No.: 19/096,716

(22) Filed: Apr. 1, 2025

(51) Int. Cl. H04L 9/40

(52) U.S. Cl. CPC H04L 63/1433

(57) ABSTRACT

An autonomous pentesting agent may detect threats and indicators of compromise (IOCs) via autonomous pentesting and execute actions in response to detections. The agent may detect IOCs of a target network associated with a previous compromise of the target network during an autonomous pentesting operation that involves accessing network assets of the target network. In response to detecting the IOCs, the agent may automatically execute a security operation to terminate the previous compromise. The agent may obtain an indication of a set of actions associated with unauthorized access to network assets of the target network. The agent may perform a threat detection procedure to identify a previous unauthorized access by comparing the set of actions with logs of the target network that indicate a record of actions performed on the target network. The agent may automatically execute a compromise mitigation procedure in response to the indication of previous unauthorized access.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support threat detection and indicators of compromise (IOCs) detection in autonomous pentesting.

In some aspects, the techniques described herein relate to a method for compromise detection via autonomous pentesting including: executing an autonomous pentesting operation on a target network, the autonomous pentesting operation accessing one or more network assets of the target network; detecting, via the autonomous pentesting operation, one or more IOCs of the target network, the one or more IOCs being associated with a previous compromise of the target network; and executing, in response to obtaining the indication of the previous compromise, a security operation to implement one or more actions to terminate the previous compromise of the target network via the one or more IOCs of the target network, wherein the security operation is executed automatically in response to identifying the one or more IOCs of the target network.

In some aspects, the techniques described herein relate to a method for threat detection via autonomous pentesting including: obtaining, via an autonomous pentesting operation of a target network, an indication of a set of actions associated with unauthorized access to one or more network assets of the target network; performing a threat detection procedure on the target network to identify a previous unauthorized access to the one or more network assets of the target network by comparing the indication of the set of actions obtained via the autonomous pentesting operation with one or more logs associated with the target network, wherein the one or more logs indicate actions performed on the target network prior to the autonomous pentesting operation; and automatically executing a compromise mitigation procedure in response to the indication of the previous unauthorized access obtained via the threat detection procedure.

In some aspects, the techniques described herein relate to an apparatus for compromise detection via autonomous pentesting, including: one or more memories storing processor-executable code; and one or more processors coupled with the one or more memories and individually or collectively operable to execute the code to cause the apparatus to: execute an autonomous pentesting operation on a target network, the autonomous pentesting operation accessing one or more network assets of the target network; detect, via the autonomous pentesting operation, one or more IOCs of the target network, the one or more IOCs being associated with a previous compromise of the target network; and execute, in response to obtaining the indication of the previous compromise, a security operation to implement one or more actions to terminate the previous compromise of the target network via the one or more IOCs of the target network, wherein the security operation is executed automatically in response to identifying the one or more IOCs of the target network.

In some aspects, the techniques described herein relate to an apparatus for threat detection via autonomous pentesting, including: one or more memories storing processor-executable code; and one or more processors coupled with the one or more memories and individually or collectively operable to execute the code to cause the apparatus to: obtaining, via an autonomous pentesting operation of a target network, an indication of a set of actions associated with unauthorized access to one or more network assets of the target network; performing a threat detection procedure on the target network to identify a previous unauthorized access to the one or more network assets of the target network by comparing the indication of the set of actions obtained via the autonomous pentesting operation with one or more logs associated with the target network, wherein the one or more logs indicate actions performed on the target network prior to the autonomous pentesting operation; and automatically executing a compromise mitigation procedure in response to the indication of the previous unauthorized access obtained via the threat detection procedure

### BRIEF DESCRIPTION OF THE DRAWINGS

FIG. 1 shows an example of a computing environment that supports threat detection and indicators of compromise (IOCs) detection in autonomous pentesting in accordance with aspects of the present disclosure.

FIG. 2 shows an example of an autonomous pentest map that supports threat detection and IOCs detection in autonomous pentesting in accordance with aspects of the present disclosure.

FIG. 3 shows an example of a computing environment that supports threat detection and IOCs detection in autonomous pentesting in accordance with aspects of the present disclosure.

FIG. 4 shows an example of a computing system that supports threat detection and IOCs detection in autonomous pentesting in accordance with aspects of the present disclosure.

FIG. 5 shows an example of a flow diagram that supports threat detection and IOCs detection in autonomous pentesting in accordance with aspects of the present disclosure.

FIG. 6 shows a diagram of a system including a device that supports threat detection and IOCs detection in autonomous pentesting in accordance with aspects of the present disclosure.

FIGS. 7 and 8 show flowcharts illustrating methods that support threat detection and IOCs detection in autonomous pentesting in accordance with aspects of the present disclosure.

### DETAILED DESCRIPTION

Some networks may undergo pentests to identify security vulnerabilities and, based on identifying the security vulnerabilities, implement changes that improve network security. For example, a red team or a pentester may perform a pentest of the network to identify potential attack paths, vulnerable network assets, and information that may be compromised by an attacker. Using the results of the pentest, a blue team may implement changes in the network to address the vulnerabilities identified during the pentest. For example, the blue team may implement security policies or execute changes to the network to block or limit attack paths identified during the pentest. However, in some cases, the pentest may be unable to determine whether the identified vulnerabilities were previously exploited (e.g., used by an attacker or malicious actor in the past). That is, some pentests may not identify signs of previous compromise on, within, or associated with network assets of the network that is being tested. For example, the pentest may fail to detect that the network includes malware (e.g., malware that is already or previously installed or deployed within the network, which poses an ongoing security threat) or that data associated the network was obtained, exported, or used by a malicious actor, or the like. In such cases, pentesting may fail to identify impacts and mitigate effects of ongoing vulnerabilities associated with previous compromise events on the network.

According to techniques described herein, an autonomous pentesting agent may perform an autonomous pentest of a network to detect security threats and indicators of compromise (IOCs). For example, the autonomous pentesting agent may detect previous attacks (e.g., unauthorized access, malicious actions) on a network (or a network asset of the network) during an autonomous pentest. Additionally, the autonomous pentesting agent may recommend or execute actions (e.g., automatically) to address the detected attacks. Detecting previous attacks may involve analyzing logs of the network and comparing the logs to a log of the pentest to identify similarities. For example, the autonomous pentesting agent may execute an attack path by performing a set of actions that leads to a compromise event. The autonomous pentesting agent may scan the logs of the network to identify whether the set of actions (and therefore the compromise event) occurred in the network prior to the pentest. In such cases, the autonomous pentesting agent may recommend a security operation or take action such as by implementing changes to a security posture of the network to help proactively detect or prevent the set of actions that lead to the compromise event from being taken in the future. Additionally, or alternatively, detecting previous attacks may involve identifying IOCs such as malware, spyware, trojans, etc. or modified user or system data. For example, the autonomous pentesting agent may scan network assets along the attack path and identify whether one or more IOCs are present in at least one of the network assets. IOCs may indicate that an attacker previously accessed and/or currently has access to a network asset. If an IOC is detected, the autonomous pentesting agent may perform automatic remediation to secure network assets in which IOCs were identified. As an example, the autonomous pentesting agent may disconnect a network asset from the network such that an attacker who may have previously accessed the network asset (and deployed the IOC) can no longer leverage the IOC or access the network asset (e.g., to prevent the attacker from accessing other parts of the network based on the IOC).

By detecting and remediating previous attacks through autonomous pentesting operations, techniques described herein may improve network security. Enabling detection and remediation of previous compromise events on a network may be advantageous over other pentests that identify potential attack paths but do not identify whether the potential attack paths have been used by an attacker. For example, the autonomous pentesting agent may both detect and address security vulnerabilities that were exploited prior to the pentest, which may eliminate and/or reduce active security vulnerabilities for the network and improve network security.

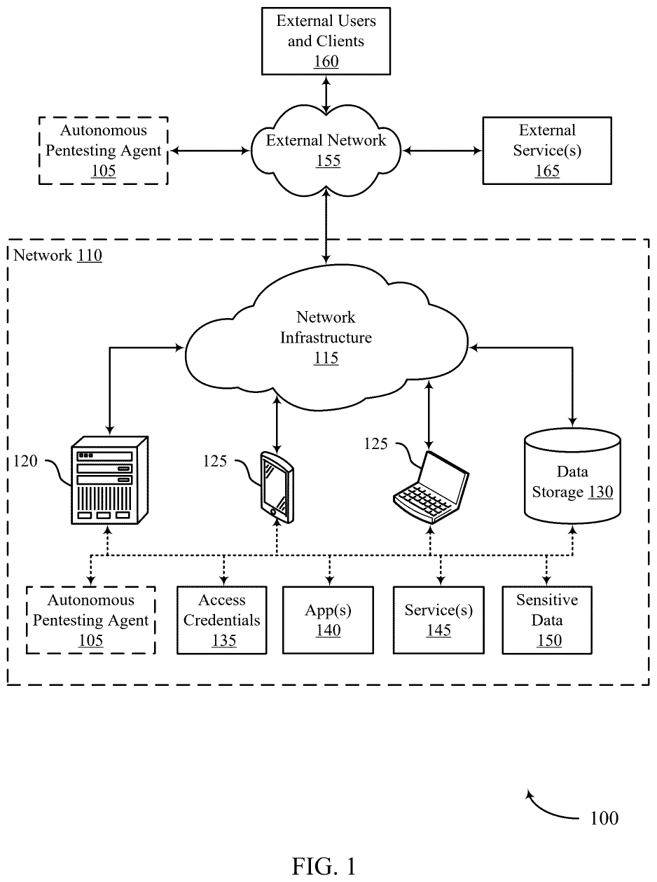

FIG. 1 illustrates an example of a computing environment 100 that supports threat detection and IOCs detection in autonomous pentesting in accordance with aspects of the present disclosure. The computing environment 100 may include an autonomous pentesting agent 105 that performs an autonomous pentest of a network 110. The network 110 may include one or more devices or systems, such as a network infrastructure 115, server 120, computing devices 125, data storage 130, or any combination thereof. The devices or systems of the network 110 may be configured to access or provide various network information and services, such as access credentials 135, app(s) 140, service(s) 145, sensitive data 150, or any combination thereof.

The network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the network 110 as well as communication between the network 110 (e.g., the private network) and an external network 155 (e.g., the Internet). The network 110 may include aspects of one or more wired networks, one or more wireless networks (e.g., cellular networks), or any combination thereof. The network 110 may include aspects of one or more public networks or private networks, as well as secured or unsecured networks, or any combination thereof. For example, the network 110 may be an example of a private network that includes one or more public-facing or external assets that are accessible via an external network 155. As an example, the external network 155 may refer to the Internet, and users, such as external users and clients 160, may access the network 110 via the external network 155 through a website or application that is on the external network 155. For example, the external users and clients 160, the external service(s) 165, or both may access network information and services via the external network 155 (e.g., via the Internet), including the access credentials 135, app(s) 140, service(s) 145, and sensitive data 150.

The network 110 may be accessible via one or more hosts. For example, hosts may be examples of real or virtual machines that are connected to and capable of accessing the network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the network 110 and outside of the network (e.g., with devices in an external network 155). For example, the server 120 may send data to and receive data from one or more of the computing devices 125. Additionally, or alternatively, hosts may access resources of the network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein, network assets refer to machines that include network shares. For example, network assets may be examples of machines (e.g., real or virtual machines) that include shares of the network 110, such as file sharing systems. Network assets may be obtained and utilized by attackers to compromise the network 110. The server 120, the computing devices 125, the data storage 130, and the access credentials 135, app(s) 140, service(s) 145, and sensitive data 150 accessible via the devices and systems of the network 110 may all be examples of network assets. For example, physical devices (e.g., servers, computing devices, data storage, etc.) and systems may be considered network assets as well as information, apps, and services accessible through physical devices and systems of the network 110.

Hosts may store, provide, or implement access credentials 135, app(s) 140, service(s) 145, sensitive data 150, or any combination thereof. In some cases, computing devices 125 on the network may access the one or more assets (e.g., access credentials 135, app(s) 140, service(s) 145, sensitive data 150, etc.) via the server 120 (e.g., via a host). Additionally, or alternatively, computing devices 125 may locally store or otherwise access the one or more assets of the network 110. For example, users of the network 110 may access app(s) 140 and service(s) 145 via the computing devices 125 directly or indirectly (e.g., via a connection between the computing devices 125 and the server 120).

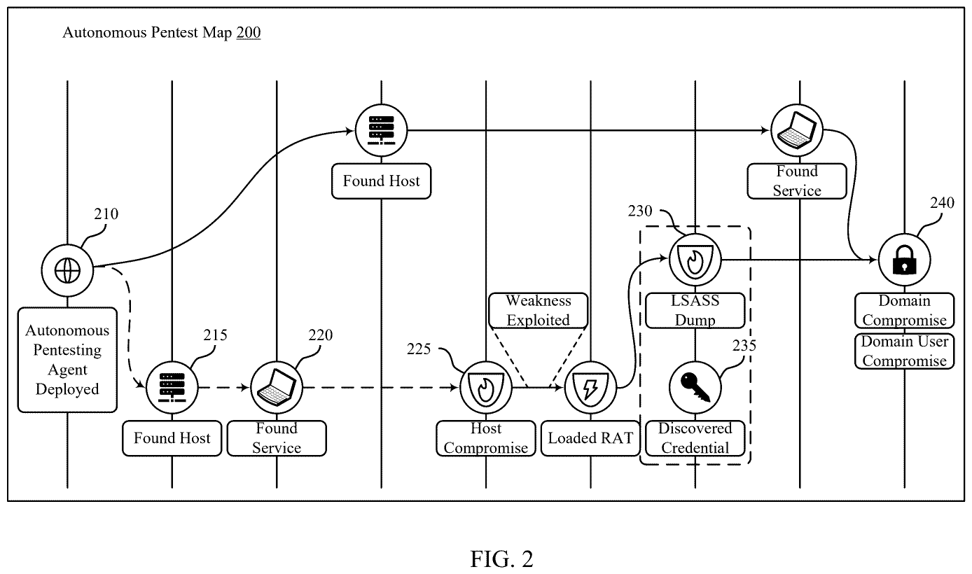

The autonomous pentesting agent 105 may perform a pentest of the network 110. As used herein, a penetration test or a “pentest” may refer to one or more security operations that simulate a cybersecurity attack in order to identify vulnerabilities in the network 110. The autonomous pentesting agent 105 may perform the pentest of the network 110 using one or more artificial intelligence (AI) models. For example, the autonomous pentesting agent 105 may be “autonomous,” as the autonomous pentesting agent 105 may perform the pentest without a requirement of hard-coding, user inputs, or the like and, instead, by using the one or more AI models. The autonomous pentesting agent 105 may identify, via the pentest, security vulnerabilities of the network 110. An example of an output of the pentest may be described in greater detail elsewhere herein, including with reference to FIG. 2.

The autonomous pentesting agent 105 may, via the one or more AI models, determine and implement an attack path for a pentest. For example, the autonomous pentesting agent 105 may identify or select an asset of the network 110 to attempt to access initially and, from that asset, another asset to attempt to access, and so on. In other words, the autonomous pentesting agent 105 may use the one or more AI models to mimic decisions of an attacker. The one or more AI models may output a targeted asset of the network 110 to be subject to an access attempt by the autonomous pentesting agent 105 based on inputs including context of various assets in the network 110. In other words, the one or more AI models may output targeted assets based on the relative position of assets within the network 110, asset types, downstream assets (e.g., accessible after or through accessing a targeted asset), or the like.

The one or more AI models may be trained using data of previous pentests of the network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the network 110 previously or on other networks, or both. The autonomous pentesting agent 105 may perform improved pentests after the one or more AI models are trained using previous pentests of the network 110. That is, as the autonomous pentesting agent 105 learns more about the network 110, the autonomous pentesting agent 105 may perform pentests with higher performance levels (e.g., higher accuracy, higher quantities of potential attack paths, etc.).

In some cases, the pentest may be internal or external to the network 110. For example, the autonomous pentesting agent 105 may be deployed at a host device of the network 110 (e.g., deployed to the server 120 or computing devices 125). In such examples, the autonomous pentesting agent 105 may perform the pentest as an internal user of the network 110. Such internal pentests may be indicative of or emulate internal security threats to the network, such as from employees of an organization or an attacker that has otherwise obtained access to the network 110 internally. Alternatively, the autonomous pentesting agent 105 may be deployed at the external network 155. For example, the autonomous pentesting agent 105 may perform the pentest as an external user of the network 110, such as by accessing external or public-facing assets of the network 110 on the external network 155.

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the network 110 against cybersecurity attacks relative to hard-coded (e.g., automated) or manual (e.g., human operated) pentests.

As described herein, the autonomous pentesting agent 105 may improve security of the network 110 by performing an autonomous pentest that detects previous compromise events in the network 110. For example, the autonomous pentesting agent 105 may gain unauthorized access to a computing device 125 in the network 110. At the computing device 125, the autonomous pentesting agent 105 may identify one or more IOCs, access a log of the network 110 (or a log of a system such as an operating system of a host device) which indicates one or more actions that may lead to or have led to a compromise event, or both. That is, the autonomous pentesting agent 105 may perform “threat hunting,” which may refer to scanning for malicious activity that happened in the past (e.g., prior to the autonomous pentest) or could happen in the future. The autonomous pentesting agent 105 may automatically implement a security measure to terminate a potentially ongoing compromise event (e.g., in the case of identification of one or more IOCs), implement mitigation features to prevent future or further compromise events, or both. By detecting indicators of previous compromise events and implementing security measures that prevent the occurrence of such compromise events in the future, the autonomous pentesting agent 105 may improve security of the network 110.

FIG. 2 shows an example of an autonomous pentest map 200 that supports threat detection and IOCs detection in autonomous pentesting in accordance with aspects of the present disclosure. The autonomous pentest map 200 may be an example of an output or result of an autonomous pentest performed by an autonomous pentesting agent, such as a pentest performed by the autonomous pentesting agent 105 in the network 110 as described with reference to FIG. 1. The autonomous pentest map 200 may illustrate and describe an example of events of a pentest, including operations performed by and information obtained by the autonomous pentesting agent.

The autonomous pentest map 200 may include one or more types of events. For example, the autonomous pentest map 200 may include deployment 210 (e.g., of the autonomous pentesting agent), host identification 215, service identification 220, host compromise 225, deployment of an attacker tool 230 (e.g., a remote access trojan (RAT), credential identification 235, and access 240 (e.g., to a domain, a domain user, or both). The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent pay perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support threat and IOC detection. The autonomous pentesting service may generate a log of an autonomous pentest where the log includes or indicates a list or set of actions performed by the autonomous pentesting service. The log may indicate one or more events shown in the autonomous pentest map 200. As an example, the log may indicate access to a host, loading of a RAT on the host, or use of a credential on a service. The autonomous pentesting service may use the generated log of the autonomous pentest to identify similar sequences of actions within a log of a compromised network asset. That is, the autonomous pentesting service may compare the log of the actions performed by the autonomous pentest to a log associated with a network asset to identify whether a previous compromise has occurred at the network asset. For example, the autonomous pentesting service may identify whether the credential used by the autonomous pentesting service was previously used. Use of the credential may be indicative of compromise, as the autonomous pentesting service was able to compromise the domain and domain user via the credential. If the autonomous pentesting service identifies a similar sequence of actions in the log of the network asset, the autonomous pentesting service may implement one or more security measures, such as mechanisms to detect whether the sequence of actions occurs in the future, block or limit access to one or more actions in the sequence of actions, or the like.

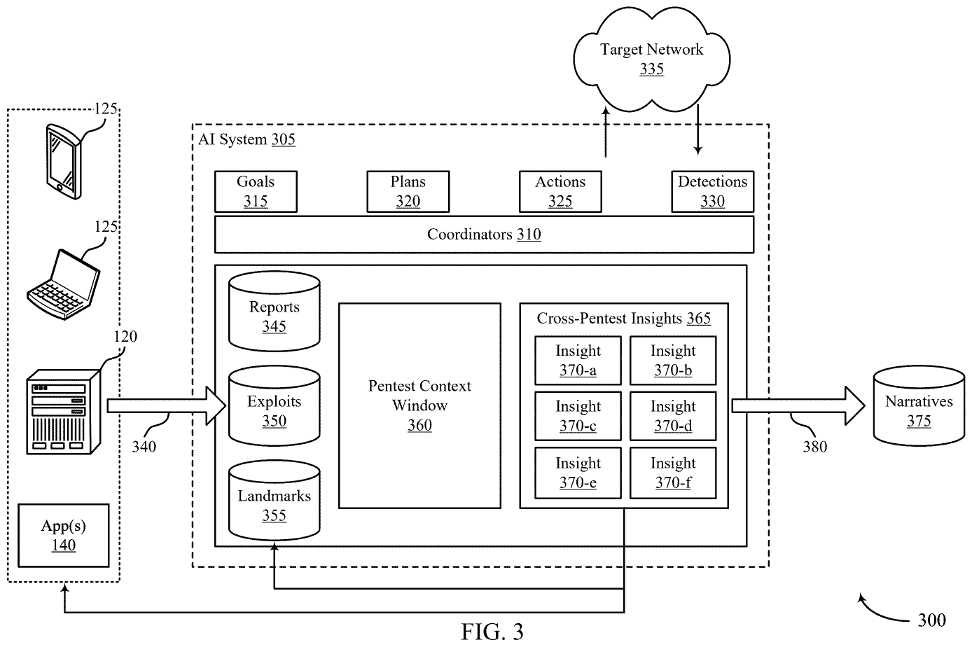

FIG. 3 shows an example of a computing environment 300 that supports threat detection and IOCs detection in autonomous pentesting in accordance with aspects of the present disclosure. The computing environment 300 may implement or be implemented by the computing environment 100, the autonomous pentest map 200, or both. For example, the computing environment 300 may illustrate servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions. In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing. In some examples, the AI system 305 may utilize a large language model (LLM) which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously, at least for some operations, to achieve specified goals, make decisions, and take actions without direct human intervention (e.g., through the use of AI agents). In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a network 110, compromise (such as by obtain unauthorized administrative access or deploying unauthorized software to) a domain or a network asset of the network 110, or any combination thereof. To obtain the goals 315, the AI system 305 may generate one or more plans 320 that are based on actions 325 and detections 330. For example, to determine a next best action within a defined set of guardrails or instructions, the AI system 305 may generate a plan 320 that can include an action 325 to invoke (e.g., execute) one or more commands on a target network 335 to obtain a detection 330 from the target network 335.

In some examples, the target network may include one or more network assets such as servers 120, computing devices 125, data storages 130, app(s) 140, or any combination thereof. Further, obtaining a detection 330 from the target network 335 may include the AI system 305 retrieving telemetry data from the one or more network assets of the target network 335. In some cases, telemetry data obtained from the target network 335 may include logs, traces, metrics, events, or any combination thereof from the one or more network assets of the target network 335. For example, a detection 330 may include some data that is obtained from the target network 335 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 335, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, or billions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 thar resulted in the action 325 succeeding or failing, or any combination thereof. Therefore, the AI system 305 may continuously obtain and update the training data used for training AI/ML models and perform reinforcement learning using collective intelligent to improve the weights and training of the AI/ML models.

In some examples, the training data for the AI system 305 may include telemetry data obtained from the target network 335, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 335) to assist the AI system 305 to navigate and map a target environment during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by proving the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 335, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may processes information about ongoing pentests, including successfully exploited vulnerabilities, accessed systems and data, attempted but failed exploit paths, among others.

In some examples, the AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 370-e, and an insight 370-f). For example, the insight 370-a may indicate patterns of vulnerable default configurations in commonly used enterprise software. In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant network compromise. Therefore, the cross-pentest insights 365 may indicate one or more insights 370 that represent patterns and vulnerabilities that occur across different networks and testing scenarios, helping organizations better understand systemic security weaknesses that need to be addressed. For example, the cross-pentest insights 365 may be added as landmarks 355 for further training the AI system 305 to perform autonomous pentests.

In some examples, the cross-pentest insights 365 may be displayed to one or more computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a network 110. In another example, a narrative 375 may be a presentation for a company or organization that indicates the one or more vulnerabilities in a network 110 associated with the company or organization. For example, the presentation can indicate the cross-pentest insights 365 obtained from performing one or more autonomous pentests on the network 110 associated with the company or organization (e.g., the target network 335).

An autonomous pentesting service may utilize the AI system 305 to identify threats and IOCs in the target network 335. For example, the autonomous pentesting service may use the AI system 305 to identify whether a network asset includes one or more IOCs. That is, the autonomous pentesting service may provide features of the network asset as input to the AI system 305. Based on the training, the AI system 305 may output an indication of whether the network asset includes IOCs. The AI system 305 may be trained using rules for IOC detection, such as Structured Threat Information Expression (STIX) or Yet Another Recursive Acronym (YARA) rules. In such examples, the autonomous pentesting service may use the AI system 305 to identify the presence of one or more features indicative of IOCs according to the STIX or YARA rules.

Additionally, or alternatively, the autonomous pentesting service may use the AI system 305 to identify sequences of actions indicative of compromise events in system logs. For example, the AI system 305 may be trained to identify the sequences of actions indicative of compromise events based on logs of pentesting operations that executed attacks and achieved compromise events. That is, the cross-pentest insights 365 may include sequences of actions and associated compromise events, which may be used to train the AI system 305 to identify occurrences of compromise events.

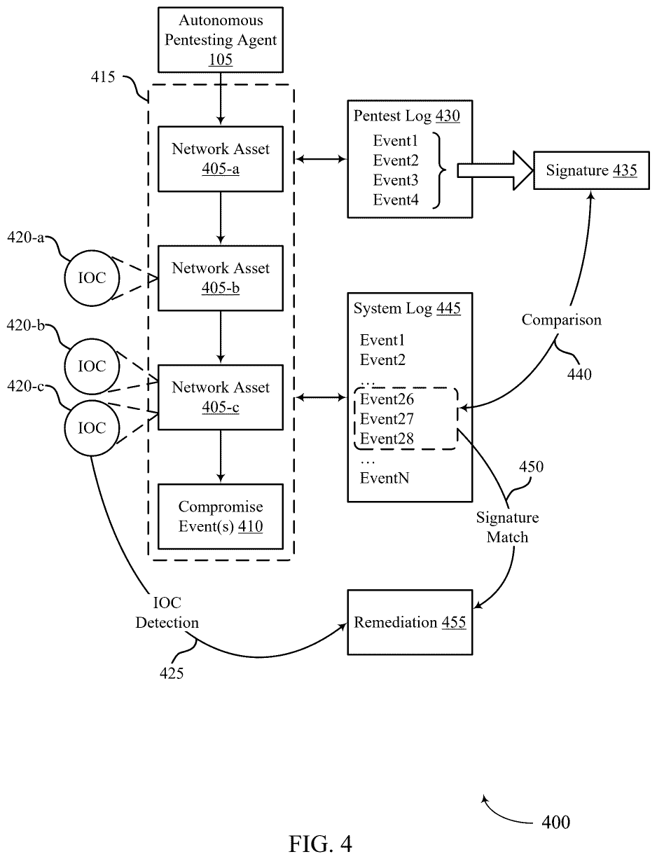

FIG. 4 shows an example of a system 400 that supports threat detection and IOCs detection in autonomous pentesting in accordance with aspects of the present disclosure. The system 400 may implement or be implemented by the computing environment 100, the autonomous pentest map 200, the computing environment 300, or any combination thereof. For example, the system 400 may illustrate an autonomous pentesting agent 105 gaining unauthorized access to a network asset 405-a, a network asset 405-b, and a network asset 405-c to achieve compromise event(s) 410 in an attack path 415.

The autonomous pentesting agent 105 may execute an autonomous pentest of a network. For example, the autonomous pentesting agent 105 may execute an autonomous pentesting operation in which the autonomous pentesting agent gains access to the network asset 405-a, the network asset 405-b, and the network asset 405-c via attack path 415. Additionally, the autonomous pentesting operation may include the compromise event(s) 410. As shown, the autonomous pentesting operation may follow an attack path 415 that indicates an order of events for the pentesting operation. That is, in the attack path 415, the autonomous pentesting agent 105 may access the network asset 405-a, the network asset 405-b, then the network asset 405-c and, afterward, achieve the compromise event(s) 410.

By executing the autonomous pentesting operation, the autonomous pentesting agent 105 may identify vulnerabilities at each of the network assets 405 that are associated with the compromise event(s) 410 (e.g., enable the compromise event(s) 410 to occur). For example, the autonomous pentesting agent 105 may exploit vulnerabilities discovered during pentesting (e.g., at each of the network assets 405) to achieve compromise event(s) 410. That is, the autonomous pentesting agent 105 may attempt to identify and/or gain unauthorized access to network assets 405 within a network (e.g., of an organization) and use the identified and/or accessed network assets 405 to identify and exploit vulnerabilities to achieve the compromise event(s) 410. Additionally, the autonomous pentesting agent 105 may identify whether the attack path 415 may have been executed previously in the network, such as by a malicious actor. For example, the autonomous pentesting agent 105 may identify one or more IOCs at the network assets 405 and/or identify actions or events within a system log 445 indicative of compromise event(s) 410.

The autonomous pentesting agent 105 may identify one or more IOCs during the pentest. For example, the autonomous pentesting agent 105 may identify IOC 420-a at the network asset 405-b and IOC 420-b and IOC 420-c at the network asset 405-c. The autonomous pentesting agent 105 may identify IOCs 420 through access to the network assets 405-b and 405-c obtained during the autonomous pentest. That is, the autonomous pentesting agent 105 may exploit a vulnerability to gain unauthorized access to (e.g., compromise) the network asset 405-b and then, using the unauthorized access, scan for IOCs 420.

The one or more IOCs 420 may include installation of malicious software or tools (e.g., trojans, spyware, adware, viruses, worms), manipulation of data (e.g., user data, system data, firmware, software) within the network asset (e.g., within hosts), or the like. For example, the autonomous pentesting agent 105 may identify a RAT in memory of the network asset 405-b (e.g., a host device). In some examples, the autonomous pentesting agent 105 may identify the one or more IOCs 420 in accordance with a set of standards, such as STIX or YARA rules. For example, STIX rules may include descriptions and associated textual or binary patterns of cybersecurity threats, while YARA rules may include textual or binary patterns of malware. In some examples, the autonomous pentesting agent 105 may identify the one or more IOCs 420 using an AI model trained via the STIX and YARA rules.

Additionally or alternatively, the autonomous pentesting agent 105 may identify artifacts of compromise. For example, artifacts of compromise may include registry keys that may have been inserted or modified at host devices, files placed in memory of host devices due to the action of an attacker, or both. That is, the autonomous pentesting agent 105 may identify evidence of attacks in different locations on network assets, including on host devices. The autonomous pentesting agent 105 may use the identified artifacts in combination with other indications of previous attacks, such as IOCs and events in logs, to determine whether compromise events occurred prior to the pentest and, if so, how the compromise events were achieved by attackers.

In addition to or alternatively from identifying the IOCs, the autonomous pentesting agent 105 may analyze a system log 445 to identify occurrence(s) of previous compromise events. The autonomous pentesting agent 105 may obtain one or more logs (e.g., including the system log 445) during the pentesting operation. For example, the autonomous pentesting agent 105 may obtain one or more logs via a host compromised during the pentest, an application or service through which the host was compromised, or a credential used to compromise the host. The one or more logs may include one or more network logs, one or more system logs, one or more user logs, or any combination thereof. In some examples, the one or more logs may include logs within a centralized logging solution, such as a Security Information and Event Management (SIEM) system. Additionally, or alternatively, the one or more logs may include operating system logs such as Microsoft Windows event logs, journald (e.g., in the example of Linux systems), application logs, or the like.

The autonomous pentesting agent 105 may match events performed during the pentest with the one or more logs. In the example of FIG. 4, the autonomous pentesting agent 105 may compare a pentest log 430 of events (Events 1, 2, 3, and 4) corresponding to the attack path 415 (e.g., the pentesting operation) with a system log 445 of events (Events 1 through N). For example, once a series of events associated with the attack path 415 is identified, the autonomous pentesting agent 105 may access the one or more logs to determine whether a similar series of events has occurred in the past (e.g., prior to the pentesting operation including the attack path 415). In some examples, a similar series of events may refer to a set of signatures or log entries occurring in a same order as the attack path 415. Additionally, or alternatively, a similar series of events may refer to events with one or more variations from the series of events associated with the attack path 415. In such examples, the autonomous pentesting agent 105 may generate a similarity score indicative of probability of the similar series of events indicating a previous attack. The autonomous pentesting agent 105 may filter the system log 445 to remove events associated with the attack path 415. For example, the autonomous pentesting agent 105 may filter events in the system log 445 based on timestamps of activities of the autonomous pentesting agent 105.

The autonomous pentesting agent 105 may generate a signature 435 based on the pentest log 430. That is, the autonomous pentesting agent 105 may generate a signature 435 (e.g., an “on-the-fly” signature) representative of the series of events by which the autonomous pentesting agent 105 achieved the compromise event(s) 410. In some examples, the autonomous pentesting agent 105 may use the filtered events from the system log 445 (e.g., based on the timestamps of the activities of the attack path 415) to generate the pentest log 430 and/or generate the signature 435. The signature 435 may take the form of a sequence of events in various logs and, in some examples, may be used to generate YARA, STIX, or organization-specific rules that define “malicious” activity. Additionally, or alternatively, the signature 435 may take into account an application, host, and potential credential tied to activities, log event types tied to these entities, and log message contents. For instance, for application logs, the autonomous pentesting agent 105 may look for exceptions or errors that occurred around a given time frame. If a credential was used, the autonomous pentesting agent 105 may look for login events in an application, host, or domain.

Using the signature 435, the autonomous pentesting agent 105 may perform a comparison 440 between the signature 435 and sequences of events in the system log 445. That is, the autonomous pentesting agent 105 may scan (e.g., search) the system log 445 for sequences of events that follow a same pattern as the signature 435 or leverage similar vulnerabilities. Put another way, the autonomous pentesting agent 105 may search past log history across log sources (e.g., one or more logs, including the system log 445 in the example of FIG. 4) with the signature 435 and determine if there are matches. As an example, the autonomous pentesting agent 105 may scan for login events associated with a given application, host, or domain if a credential was used to achieve the compromise event(s) 410. A pattern of events or use of a network asset associated with the compromise event(s) 410 may indicate that the network was previously compromised in a similar manner (e.g., similar to the attack path 415 performed by the autonomous pentesting agent 105).

The autonomous pentesting agent 105 may perform one or more modifications to the signature 435. For example, the autonomous pentesting agent 105 may identify one or more false positives, one or more false negatives, or both during the comparison 440. The autonomous pentesting agent 105 may modify (e.g., tune, in some examples automatically) the signature 435 to balance the false positives and negatives. For example, the autonomous pentesting agent 105 may initially tune the signature 435 to minimize false positives and gradually adjust the signature (e.g., widen the error) such that the signature 435 may generate a greater quantity of matches. The autonomous pentesting agent 105 may lock the signature 435 (e.g., terminate the performance of one or more modifications) when a configured threshold of false positives is achieved via the one or more modifications. As an example, an IOC for an attack may be a presence of a file path created during an exploitation. If this file path is frequently used by other legitimate sources, using the presence of the file path as an IOC may generate false positives (e.g., flag legitimate uses of the file path). Accordingly, the autonomous pentesting agent 105 may tune the IOC to be more restrictive (e.g., include aspects in addition to and/or alternatively from the presence of the file path) and eliminate these false positives.

In some examples, the autonomous pentesting agent 105 may implement one or more signatures to be used by persistent detection components after completion of the autonomous pentest. For example, the autonomous pentesting agent 105 may establish, in the system log 445, the signature 435 that denotes a series of events associated with the compromise event(s) 410 that are to be avoided in the future. Put another way, the autonomous pentesting agent 105 may store the signature 435 in the system log 445. By storing the signature 435 in the system log 445, the persistent detection components may track whether the signature occurs in the future. For example, one or more persistent detection components in the network may monitor the system log 445 (e.g., monitor one or more logs in the network) to identify events indicative of the compromise event(s) 410 according to the signature 435. The one or more persistent detection components may include a SIEM solution, an Endpoint Detection and Response (EDR) solution, or a precision EDR or RAT that the autonomous pentesting agent 105 installs and runs (e.g., permanently) on one or more network assets in the attack path 415.

The autonomous pentesting agent 105 may collect forensic information (e.g., digital forensics). For example, based on an IOC detection 425 and/or a signature match 450, the autonomous pentesting agent 105 may isolate network assets and collect forensic information. The forensic information may indicate how an attacker achieved an identified compromise. The autonomous pentesting agent 105 may shift to a forensics virtual local area network (LAN). That is, the autonomous pentesting agent 105 may collect forensic information at a network asset while keeping the network asset online (e.g., connected to other network assets within the network and/or an external network). By keeping the network asset online, the autonomous pentesting agent 105 may collect the forensic information without alerting the attacker to detection of their malware or attack.

The autonomous pentesting agent 105 may perform a compromise detection procedure, such as remediation 455, immediately and/or automatically based on the IOC detection 425 and/or the signature match 450. Performing the remediation 455 may be based on a type of detection. In other words, the autonomous pentesting agent 105 may address current and/or future security threats based on the type of detection. That is, when the autonomous pentesting agent 105 detects an IOC that is currently active within the network, such as malicious software or tools installed on a host device, the autonomous pentesting agent 105 may perform actions within the network to terminate the active IOC. For example, the autonomous pentesting agent 105 may disconnect from the network (or shut down) a host in response to the IOC detection 425. Alternatively, when the autonomous pentesting agent 105 detects a previous attack via the system log 445, the autonomous pentesting agent 105 may implement a security policy to prevent and/or detect the attack in the future. For example, the autonomous pentesting agent 105 may trigger an incident response procedure or reporting procedure to escalate the identified compromise event to a security team responsible for implementing security solutions or fixes. In another example, the autonomous pentesting agent 105 may implement rules to proactively monitor for a given series of events that would compromise a host or exploit a vulnerability within the network. The rules may involve monitoring network assets or network logs for certain types or sequences of events that would indicate compromise.

In some examples, the autonomous pentesting agent 105 may raise contextual awareness to a Security Operations Center (SOC), defensive teams, or the like for network assets 405 associated with the attack path 415. For example, the autonomous pentesting agent 105 may output a report or notification indicating network assets that were part of or adjacent to the attack path 415. Put another way, the autonomous pentesting agent 105 may indicate network assets, including systems, services, credentials, and users, directly and/or indirectly related to the attack path 415. The indication may include network assets vulnerable given the attack path 415, the compromise event(s) 410, and previous compromise events identified during the autonomous pentest. In some examples, the autonomous pentesting agent 105 may indicate network assets vulnerable over multiple pentests (e.g., using cross-pentest insights). That is, the autonomous pentesting agent 105 may flag assets that are vulnerable over multiple pentests.

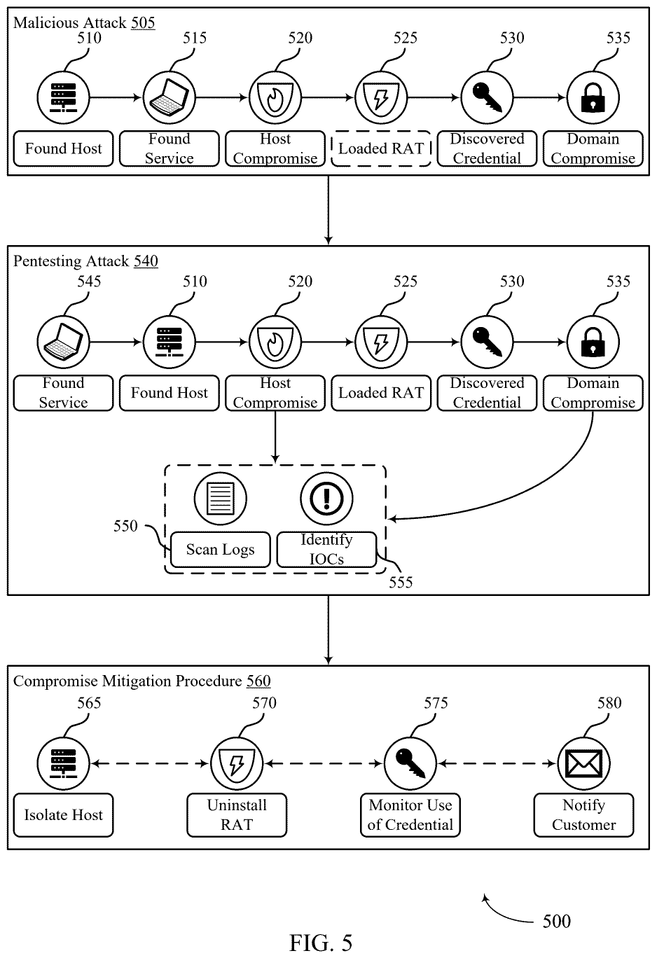

FIG. 5 shows an example of a flow diagram 500 that supports threat detection and IOCs detection in autonomous pentesting in accordance with aspects of the present disclosure. The flow diagram 500 may implement or be implemented by the computing environment 100, the autonomous pentest map 200, the computing environment 300, the system 400, or any combination thereof. For example, the flow diagram 500 may illustrate a malicious attack 505 of a network, a pentesting attack 540 of the network, and compromise mitigation procedure 560 based on detection of the malicious attack 505 during the pentesting attack 540.

An attacker may execute the malicious attack 505 of a network. The malicious attack 505 may include an attack path where the attacker finds a host 510, finds a service 515, achieves host compromise 520, loads a RAT 525, discovers a credential 530, and achieves domain compromise 535. The malicious attack 505 may leave behind IOCs or indicators of actions performed by the malicious attack 505 within the network, such as in one or more logs or as IOCs or artifacts in memory of various network assets.

After the malicious attack 505, an autonomous pentesting agent may execute a pentesting attack 540 of the same network. A pentest may exploit vulnerabilities discovered during pentesting to achieve network asset compromise. That is, a pentest may attempt to identify and/or gain unauthorized access to network assets within an organization's network. Once identified or accessed, the pentest may identify vulnerabilities within the network, exploit the identified vulnerabilities to compromise the asset and gain host compromise (or full domain compromise). In the pentesting attack 540 in the example of FIG. 5, the autonomous pentesting agent may find a service 545, find the host 510, achieve host compromise 520, load the RAT 525, discover a credential 530, and achieve domain compromise 535.

Once compromise is achieved, the pentest may be configured to look for signs that the domain (or network assets within the network) was already compromised (such as by a malicious actor). To do this, the pentest may match events performed during the pentest with network or system logs, such as logs stored in a centralized logging solution (e.g., within an SIEM system) or logs that are maintained or obtained during the pentest.

The network or system logs may be related to the host that is compromised during the pentest, the application or service through which the host was compromised, or a credential used to compromise the host. For instance, once a series of events associated with an attack path has been identified, the pentest can access the logs to determine whether a similar series of events has occurred in the past. That is, the autonomous pentesting agent 105 may scan logs 550 based on achieving the host compromise 520 and/or the domain compromise 535 during the pentesting attack 540.

The autonomous pentesting agent may generate an “on-the-fly” signature that is representative of the series of events by which the pentest achieved compromise (e.g., representative of the pentesting attack 540). The autonomous pentesting agent may look, in the logs, for sequences of events that follow a same pattern or leverage similar vulnerabilities as the pentesting attack 540 (e.g., look for login events into an application, host, or domain if a credential was used for compromise). If so, this may indicate that the system (or network asset) has been previously compromised in a similar fashion (i.e., similar to the pentesting attack 540 performed by the autonomous pentesting agent). As an example, the autonomous pentesting agent may scan logs 550 to identify whether the credential 530 discovered during the pentesting attack 540 was obtained (e.g., through communications with one or more other network assets) or used previously.

In some examples, the signature may be tuned to balance false positives and false negatives. For example, initially, the signature may be tuned to eliminate false positives, and the autonomous pentesting agent may gradually loosen the signature (widen the error) to generate more matches. As an example, the signature may initially represent the exact order of finding the service 545 then the host 510, and so on, but be modified to scan for finding the host 510 and then the service 515 (as was the case for the malicious attack 505). In another example, the signature may represent using the credential at a specific application but be modified to scan for attempted use of the credential at other applications and services (e.g., which may indicate that an attacker attempted to identify an application or service where the credential is usable). The pentest may lock the signature when a configured threshold for false positives is reached.

Additionally, the autonomous pentesting agent may be configured to look for IOCs 555 on a network asset that has been compromised during or after the pentesting attack 540. For example, an autonomous pentesting agent may exploit a vulnerability to compromise a host 510, allowing the autonomous pentesting agent to gain access to the host 510 (e.g., achieve host compromise 520). The autonomous pentesting agent may then look for or identify IOCs 555 by accessing the host 510. IOCs may include the installation of malicious software or tools (e.g., trojans, such as the RAT 525), manipulation of data within the host 510, among others. The autonomous pentesting agent may use standards to detect malicious activities, such as STIX or YARA standards.

In some aspects, the autonomous pentesting agent may look for other indicators, including registry keys that may have been inserted or modified, files placed due to the action of an attacker, or both. That is, the autonomous pentesting agent may detect “artifacts” or other evidence of attacks in various locations on the host 510. The autonomous pentesting agent may compare these discovered artifacts with the logs, IOCs, or both to piece together what happened during the malicious attack 505 (e.g., correlate logs and/or IOCs with artifacts).

The autonomous pentesting agent may detect the malicious attack 505 with a level of accuracy based on the type of exploit or compromise. For example, some exploits or compromises may be based on a Cybersecurity & Infrastructure Security Agency (CISA) advisory. As an example, a CISA advisory on lockbit ransomware may indicate that after files are encrypted, LockBit 3.0 drops a ransom note with the new filename <Ransomware ID>.README.txt and changes the host's wallpaper and icons to LockBit 3.0 branding. In such examples, finding a file with the filename <Ransomware ID>.README.txt and/or finding an event in a log corresponding to changing the wallpaper and icons may indicate, with high accuracy, the malicious attack 505.

The autonomous pentesting agent may perform a compromise mitigation procedure 560 after the pentesting attack 540. For example, after identifying an IOC or determining previous compromise based on events, the autonomous pentesting agent may be configured to take immediate remediation. As an example, the autonomous pentesting agent may be configured to disconnect from the network (or shut down) a host in which a threat was detected (e.g., an IOC was identified). That is, the autonomous pentesting agent may isolate a host 565 at which an IOC was identified during the pentesting attack 540. Additionally, or alternatively, the autonomous pentesting agent may uninstall a RAT 570 that was found as an IOC or in the logs.

The autonomous pentesting agent may set up signatures to be used by persistent detection components in the future. For example, the autonomous pentesting agent may establish, in the log, a signature that denotes a series of events associated with a compromise event that is to be avoided in the future. Then, the persistent detection components may be able to track whether the signature comes up in the future. For example, the autonomous pentesting agent may establish a signature that monitors use of the credential 575 that led to the domain compromise 535. Persistent detection components may include a SIEM solution, an EDR solution, or a precision EDR or RAT that the autonomous pentesting agent installs and runs on the affected host.

Additionally, or alternatively, the autonomous pentesting agent may trigger an incident response procedure or reporting procedure to escalate the issue to a security team responsible for implementing security solutions or fixes. For example, the autonomous pentesting agent may notify a customer 580 of the malicious attack 505.

Further, rules to proactively monitor for a given series of events that would compromise a host or exploit a vulnerability within the network could be implemented on the system. This could involve monitoring network assets or network logs for certain types or sequences of events that would indicate compromise. As for IOCs or identification of previous compromise which could be triggered upon activation of the threat or when a threat has been triggered.

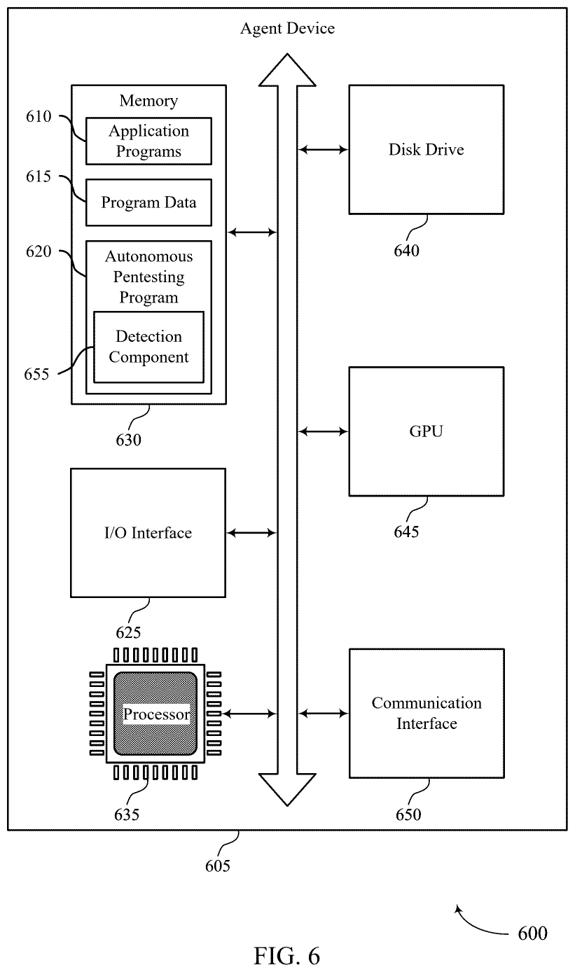

FIG. 6 shows a diagram of a system 600 including an agent device 605 that supports threat detection and IOCs detection in autonomous pentesting in accordance with aspects of the present disclosure. The agent device 605 may be an example of a device or server on which an autonomous pentesting agent 105 is deployed as described herein. The agent device 605 may include components for threat detection and IOCs detection in autonomous pentesting, such as a memory 630 including application programs 610, program data 615, an autonomous pentesting program 620, and a detection component 655; an input/output (I/O) interface 625; a processor 635; a disk drive 640; a graphics processing unit (GPU) 645; and a communication interface 650. Each of these components may communicate, directly or indirectly, with one another (e.g., via one or more buses, communications links, communications interfaces, or any combination thereof).

The I/O interface 625 may support connection of the agent device 605 with one or more other devices. For example, the agent device 605 may connect to keyboards, mice, printers, hard disks, or the like via the I/O interface 625. The I/O interface 625 may communicate with the processor 635. That is, the processor 635 may process signals from devices connected to the agent device 605 via the I/O interface 625.

Memory 630 may include RAM, ROM, or both. The memory 630 may store computer-readable, computer-executable software including instructions that, when executed, cause at least one processor 635 to perform various functions described herein, such as functions supporting threat detection and IOCs detection in autonomous pentesting. In some cases, the memory 630 may contain, among other things, a basic input/output system (BIOS), which may control basic hardware or software operation such as the interaction with peripheral components or devices. The memory 630 may be an example of a single memory or multiple memories. For example, the agent device 605 may include one or more memories 630.

The application programs 610 in the memory 630 may be examples of app(s) 140 as described with reference to FIG. 1. For example, the application programs 610 may be installed on the memory 630 of the agent device 605, among other devices in a network. The application programs 610 may be examples of software applications or computer programs that are implemented to carry out one or more functions or tasks.

The program data 615 may be data related to the application programs 610. Program data 615 may be an example of or refer to running data of programs and applications installed on the memory 630 of the agent device 605. In some examples, the program data 615 may include various data, including code that allows the application programs 610 to perform the one or more functions or tasks.

The processor 635 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting threat detection and IOCs detection in autonomous pentesting). Though a single processor 635 is depicted in the example of FIG. 6, it is to be understood that the system 600 may include any quantity of one or more of processors 635 and that a group of processors 635 may collectively perform one or more functions ascribed herein to a processor, such as the processor 635. The processor 635 may be an example of a single processor or multiple processors. For example, the agent device 605 may include one or more processors 635.

The disk drive 640 may be configured to store data that is generated, processed, stored, or otherwise used by the system 600. In some cases, the disk drive 640 may include one or more hard disk drives (HDDs), one or more solid-state drives (SSDs), or both. In some examples, the disk drive 640 may be an example of a single database, a distributed database, multiple distributed databases, a data store, a data lake, or an emergency backup database. In some examples, the disk drive 640 may be an example of one or more components described with reference to FIG. 1.

GPU 645 may be configured to store graphics-related data. The GPU 645 may store and manage data related to graphics and video processing. In some examples, the GPU 645 may be an example of or a component of a graphics card. The GPU 645 may use components of the memory 630, including the RAM, for temporary storage. For example, the GPU 645 may move data from the RAM of the memory 630 to the GPU 645 for graphics and video processing.

The communication interface 650 may enable the agent device 605 to exchange information (e.g., input information, output information, or both) with other systems or devices (not shown). For example, the communication interface 650 may enable the agent device 605 to connect to a network (e.g., a network 110 as described herein). The communication interface 650 may include one or more wireless network interfaces, one or more wired network interfaces, or any combination thereof.

The autonomous pentesting program 620 may be an example of a program of an autonomous pentesting service that is installed on the memory 630 of the agent device 605. The autonomous pentesting program 620 may execute an autonomous pentest of a network accessed by the agent device 605, such as accessed via the communication interface 650. That is, the autonomous pentesting program 620 may be configured to perform an autonomous pentest as described herein, including an autonomous pentest involving compromise and threat detection via autonomous pentesting.

The detection component 655 may support compromise detection via autonomous pentesting in accordance with examples as disclosed herein. For example, the detection component 655 may be configured as or otherwise support a means for executing an autonomous pentesting operation on a target network, the autonomous pentesting operation accessing one or more network assets of the target network. The detection component 655 may be configured as or otherwise support a means for detecting, via the autonomous pentesting operation, one or more IOCs of the target network, the one or more IOCs being associated with a previous compromise of the target network. The detection component 655 may be configured as or otherwise support a means for executing, in response to obtaining the indication of the previous compromise, a security operation to implement one or more actions to terminate the previous compromise of the target network via the one or more IOCs of the target network, where the security operation is executed automatically in response to identifying the one or more IOCs of the target network.

The detection component 655 may support threat detection via autonomous pentesting in accordance with examples as disclosed herein. For example, the detection component 655 may be configured as or otherwise support a means for obtaining, via an autonomous pentesting operation of a target network, an indication of a set of actions associated with unauthorized access to one or more network assets of the target network.

The detection component 655 may be configured as or otherwise support a means for performing a threat detection procedure on the target network to identify a previous unauthorized access to the one or more network assets of the target network by comparing the indication of the set of actions obtained via the autonomous pentesting operation with one or more logs associated with the target network, where the one or more logs indicate actions performed on the target network prior to the autonomous pentesting operation. The detection component 655 may be configured as or otherwise support a means for automatically executing a compromise mitigation procedure in response to the indication of the previous unauthorized access obtained via the threat detection procedure.

By including or configuring the detection component 655 in accordance with examples as described herein, the agent device 605 may support techniques for improved network security.

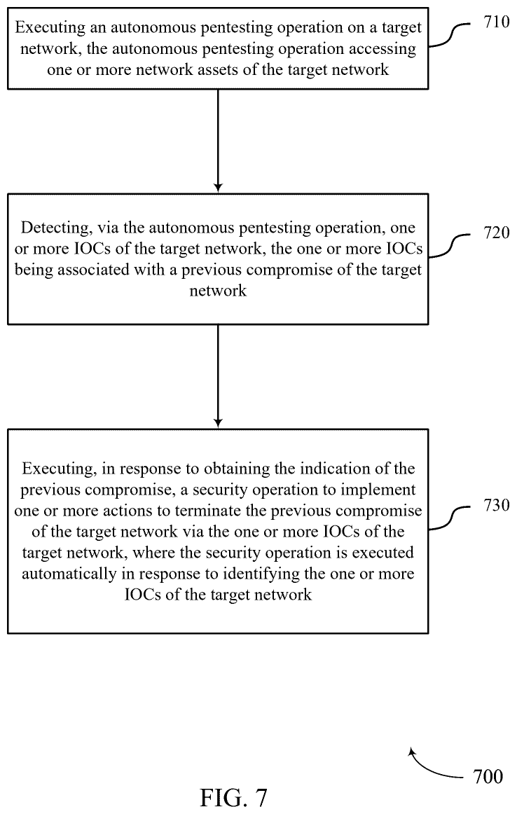

FIG. 7 shows a flowchart illustrating a method 700 that supports threat detection and IOCs detection in autonomous pentesting in accordance with aspects of the present disclosure. The operations of the method 700 may be implemented by an agent device 605 or its components as described herein. In some examples, an agent device may execute a set of instructions to control the functional elements of the agent device to perform the described functions. Additionally, or alternatively, the agent device may perform aspects of the described functions using special-purpose hardware.

At 710, the method may include executing an autonomous pentesting operation on a target network, the autonomous pentesting operation accessing one or more network assets of the target network.

At 720, the method may include detecting, via the autonomous pentesting operation, one or more IOCs of the target network, the one or more IOCs being associated with a previous compromise of the target network.

At 730, the method may include executing, in response to obtaining the indication of the previous compromise, a security operation to implement one or more actions to terminate the previous compromise of the target network via the one or more IOCs of the target network, where the security operation is executed automatically in response to identifying the one or more IOCs of the target network.

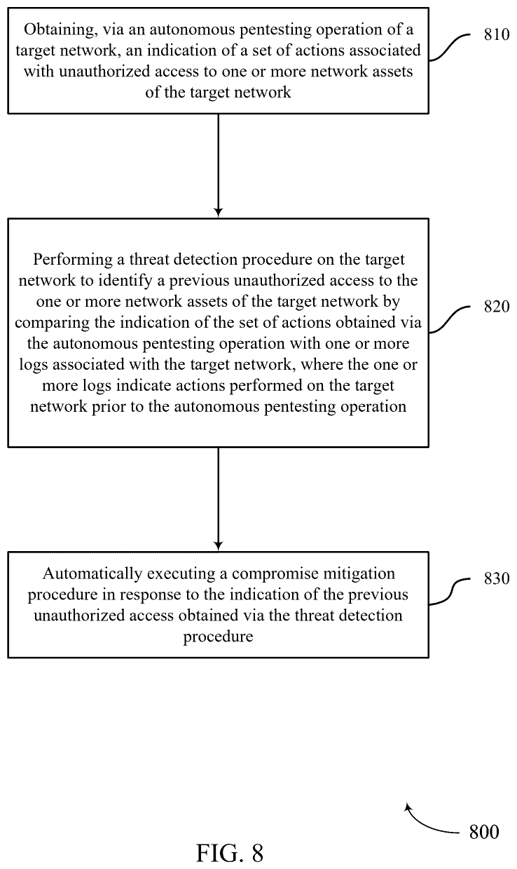

FIG. 8 shows a flowchart illustrating a method 800 that supports threat detection and IOCs detection in autonomous pentesting in accordance with aspects of the present disclosure. The operations of the method 800 may be implemented by an agent device 605 or its components as described herein. In some examples, an agent device may execute a set of instructions to control the functional elements of the agent device to perform the described functions. Additionally, or alternatively, the agent device may perform aspects of the described functions using special-purpose hardware.

At 810, the method may include obtaining, via an autonomous pentesting operation of a target network, an indication of a set of actions associated with unauthorized access to one or more network assets of the target network.

At 820, the method may include performing a threat detection procedure on the target network to identify a previous unauthorized access to the one or more network assets of the target network by comparing the indication of the set of actions obtained via the autonomous pentesting operation with one or more logs associated with the target network, wherein the one or more logs indicate actions performed on the target network prior to the autonomous pentesting operation.

At 830, the method may include automatically executing a compromise mitigation procedure in response to the indication of the previous unauthorized access obtained via the threat detection procedure.

The following provides an overview of aspects of the present disclosure:

Aspect 1: A method for compromise detection via autonomous pentesting comprising: executing an autonomous pentesting operation on a target network, the autonomous pentesting operation accessing one or more network assets of the target network; detecting, via the autonomous pentesting operation, one or more IOCs of the target network, the one or more IOCs being associated with a previous compromise of the target network; and executing, in response to obtaining the indication of the previous compromise, a security operation to implement one or more actions to terminate the previous compromise of the target network via the one or more IOCs of the target network, wherein the security operation is executed automatically in response to identifying the one or more IOCs of the target network.

Aspect 2: The method of aspect 1, wherein detecting the one or more IOCs comprises: identifying an installation of malicious software or tools at the one or more network assets, manipulation of data associated with the one or more network assets, or both.

Aspect 3: The method of any of aspects 1 through 2, further comprising: identifying one or more artifacts associated with the previous compromise; and determining one or more events associated with the previous compromise based at least in part on a correlation between the one or more artifacts and the one or more IOCs.

Aspect 4: The method of aspect 3, wherein the one or more artifacts comprise inserted or modified registry keys at the one or more network assets, one or more files stored at the one or more network assets, or both.

Aspect 5: The method of any of aspects 1 through 4, wherein executing the security operation comprises: disconnecting the one or more network assets from the target network, performing an incident response or reporting procedure, implementing a monitoring procedure at the target network, or any combination thereof.

Aspect 6: The method of any of aspects 1 through 5, further comprising: collecting, via an automated and remote mechanism, information about the one or more IOCs by maintaining a connection between the one or more network assets and the target network, wherein the security operation is based at least in part on the collected information.

Aspect 7: The method of any of aspects 1 through 6, wherein the one or more IOCs are detected in accordance with a STIX format or a set of YARA rules.

Aspect 8: The method of aspect 1, further comprising: outputting a network assessment report indicative of one or more second network assets associated with an attack path of the previous compromise of the target network or of the autonomous pentesting operation, or both.

Aspect 9: A method for threat detection via autonomous pentesting comprising: obtaining, via an autonomous pentesting operation of a target network, an indication of a set of actions associated with unauthorized access to one or more network assets of the target network; performing a threat detection procedure on the target network to identify a previous unauthorized access to the one or more network assets of the target network by comparing the indication of the set of actions obtained via the autonomous pentesting operation with one or more logs associated with the target network, wherein the one or more logs indicate actions performed on the target network prior to the autonomous pentesting operation; and automatically executing a compromise mitigation procedure in response to the indication of the previous unauthorized access obtained via the threat detection procedure.

Aspect 10: The method of aspect 9, wherein obtaining the indication of the set of actions associated with the unauthorized access comprises: gaining access to the one or more network assets by performing the set of actions during an autonomous pentest of the target network.

Aspect 11: The method of any of aspects 9 through 10, further comprising: generating a signature representative of the set of actions associated with the unauthorized access to the one or more network assets, wherein performing the threat detection procedure comprises comparing the signature representative of the set of actions to the actions indicated in the one or more logs.

Aspect 12: The method of aspect 11, further comprising: performing one or more modifications to the signature representative of the set of actions based at least in part on an occurrence of one or more false positives, one or more false negatives, or both during the threat detection procedure, wherein the signature having the one or more modifications is associated with a threshold error level, the threshold error level comprising a threshold quantity of false positives and a threshold quantity of false negatives.

Aspect 13: The method of any of aspects 9 through 12, further comprising: storing, in the one or more logs, a signature representative of the set of actions; and installing one or more persistent detection components that are configured to identify sets of actions indicative of a subsequent unauthorized access procedure.

Aspect 14: The method of aspect 13, wherein the one or more persistent detection components are associated with a SIEM operation, an EDR operation, a precision EDR or RAT, or any combination thereof.

Aspect 15: The method of any of aspects 9 through 14, wherein the one or more logs are associated with the one or more network assets, and wherein the one or more network assets comprise one or more hosts, one or more applications, one or more services, one or more credentials, or any combination thereof.

Aspect 16: The method of any of aspects 9 through 15, wherein the one or more logs are associated with a SIEM system.

Aspect 17: The method of any of aspects 9 through 16, wherein automatically executing the compromise mitigation procedure comprises: disconnecting the one or more network assets from the target network, performing an incident response or reporting procedure, implementing a monitoring procedure at the target network, or any combination thereof.

Aspect 18: The method of any of aspects 9 through 17, further comprising: outputting a network assessment report indicative of one or more second network assets associated with an attack path of the previous unauthorized access to the one or more network assets of the target network.

Aspect 19: An apparatus for compromise detection via autonomous pentesting, comprising: one or more memories storing processor-executable code; and one or more processors coupled with the one or more memories and individually or collectively operable to execute the code to cause the apparatus to perform a method of any of aspects 1 through 8.

Aspect 20: A non-transitory computer-readable medium storing code for compromise detection via autonomous pentesting, the code comprising instructions executable by one or more processors to perform a method of any of aspects 1 through 8.

Aspect 21: An apparatus for compromise detection via autonomous pentesting, comprising at least one means for performing a method of any aspects 1 through 8.

Aspect 22: An apparatus for threat detection via autonomous pentesting, comprising: one or more memories storing processor-executable code; and one or more processors coupled with the one or more memories and individually or collectively operable to execute the code to cause the apparatus to perform a method of any of aspects 9 through 18.

Aspect 23: A non-transitory computer-readable medium storing code for threat detection via autonomous pentesting, the code comprising instructions executable by one or more processors to perform a method of any of aspects 9 through 18.

Aspect 24: An apparatus for threat detection via autonomous pentesting, comprising at least one means for performing a method of any aspects 9 through 18.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for compromise detection via autonomous pentesting comprising:
executing an autonomous pentesting operation on a target network, the autonomous pentesting operation accessing one or more network assets of the target network;
detecting, via the autonomous pentesting operation, one or more indicators of compromise of the target network, the one or more indicators of compromise being associated with a previous compromise of the target network; and
executing, in response to obtaining the indication of the previous compromise, a security operation to implement one or more actions to terminate the previous compromise of the target network via the one or more indicators of compromise of the target network, wherein the security operation is executed automatically in response to identifying the one or more indicators of compromise of the target network.

2. The method of claim 1, wherein detecting the one or more indicators of compromise comprises:
identifying an installation of malicious software or tools at the one or more network assets, manipulation of data associated with the one or more network assets, or both.

3. The method of claim 1, further comprising:
identifying one or more artifacts associated with the previous compromise; and
determining one or more events associated with the previous compromise based at least in part on a correlation between the one or more artifacts and the one or more indicators of compromise.

4. The method of claim 3, wherein the one or more artifacts comprise inserted or modified registry keys at the one or more network assets, one or more files stored at the one or more network assets, or both.

5. The method of claim 1, wherein executing the security operation comprises:
disconnecting the one or more network assets from the target network, performing an incident response or reporting procedure, implementing a monitoring procedure at the target network, or any combination thereof.

6. The method of claim 1, further comprising:
collecting, via an automated and remote mechanism, information about the one or more indicators of compromise by maintaining a connection between the one or more network assets and the target network, wherein the security operation is based at least in part on the collected information.

7. The method of claim 1, wherein the one or more indicators of compromise are detected in accordance with a Structured Threat Information Expression (STIX) format or a set of Yet Another Recursive Acronym (YARA) rules.

8. The method of claim 1, further comprising:
outputting a network assessment report indicative of one or more second network assets associated with an attack path of the previous compromise of the target network or of the autonomous pentesting operation, or both.

9. A method for threat detection via autonomous pentesting comprising:
obtaining, via an autonomous pentesting operation of a target network, an indication of a set of actions associated with unauthorized access to one or more network assets of the target network;
performing a threat detection procedure on the target network to identify a previous unauthorized access to the one or more network assets of the target network by comparing the indication of the set of actions obtained via the autonomous pentesting operation with one or more logs associated with the target network, wherein the one or more logs indicate actions performed on the target network prior to the autonomous pentesting operation; and
automatically executing a compromise mitigation procedure in response to the indication of the previous unauthorized access obtained via the threat detection procedure.

10. The method of claim 9, wherein obtaining the indication of the set of actions associated with the unauthorized access comprises:
gaining access to the one or more network assets by performing the set of actions during an autonomous pentest of the target network.

11. The method of claim 9, further comprising:
generating a signature representative of the set of actions associated with the unauthorized access to the one or more network assets, wherein performing the threat detection procedure comprises comparing the signature representative of the set of actions to the actions indicated in the one or more logs.

12. The method of claim 11, further comprising:
performing one or more modifications to the signature representative of the set of actions based at least in part on an occurrence of one or more false positives, one or more false negatives, or both during the threat detection procedure, wherein the signature having the one or more modifications is associated with a threshold error level, the threshold error level comprising a threshold quantity of false positives and a threshold quantity of false negatives.

13. The method of claim 9, further comprising:
storing, in the one or more logs, a signature representative of the set of actions; and
installing one or more persistent detection components that are configured to identify sets of actions indicative of a subsequent unauthorized access procedure.

14. The method of claim 13, wherein the one or more persistent detection components are associated with a security information and event management (SIEM) operation, an endpoint detection and response (EDR) operation, a precision EDR or remote access trojan (RAT), or any combination thereof.

15. The method of claim 9, wherein the one or more logs are associated with the one or more network assets, and wherein the one or more network assets comprise one or more hosts, one or more applications, one or more services, one or more credentials, or any combination thereof.

16. The method of claim 9, wherein the one or more logs are associated with a security information and event management (SIEM) system.

17. The method of claim 9, wherein automatically executing the compromise mitigation procedure comprises:
disconnecting the one or more network assets from the target network, performing an incident response or reporting procedure, implementing a monitoring procedure at the target network, or any combination thereof.

18. The method of claim 9, further comprising:
outputting a network assessment report indicative of one or more second network assets associated with an attack path of the previous unauthorized access to the one or more network assets of the target network.

19. An apparatus for compromise detection via autonomous pentesting, comprising:
one or more memories storing processor-executable code; and
one or more processors coupled with the one or more memories and individually or collectively operable to execute the code to cause the apparatus to:
execute an autonomous pentesting operation on a target network, the autonomous pentesting operation accessing one or more network assets of the target network;
detect, via the autonomous pentesting operation, one or more indicators of compromise of the target network, the one or more indicators of compromise being associated with a previous compromise of the target network; and
execute, in response to obtaining the indication of the previous compromise, a security operation to implement one or more actions to terminate the previous compromise of the target network via the one or more indicators of compromise of the target network, wherein the security operation is executed automatically in response to identifying the one or more indicators of compromise of the target network.

20. The apparatus of claim 19, wherein, to detect the one or more indicators of compromise, the one or more processors are individually or collectively operable to execute the code to cause the apparatus to:
identify an installation of malicious software or tools at the one or more network assets, manipulation of data associated with the one or more network assets, or both.
